(19) United States
(12) Patent Application Publication
(10) Pub. No.: US 2026/0154096 A1
(43) Pub. Date: Jun. 4, 2026

(54) METHOD AND SYSTEM FOR EXPEDITING VIRTUAL DESKTOP SESSION LOGON

(71) Applicant: JPMorgan Chase Bank, N.A., New York, NY (US)

(72) Inventors: Edward P A LAWFORD, Ridgewood, NJ (US); Nathan ADOLFO, Tonbridge (GB); Mike WILDE, Newark, DE (US); Jesse DETERMANN, Montclair, NJ (US); Jerome RULEWICZ, JR., Bear, DE (US); Kevin FISHER, Columbus, OH (US)

(73) Assignee: JPMorgan Chase Bank, N.A., New York, NY (US)

(21) Appl. No.: 19/178,491

(22) Filed: Apr. 14, 2025

Related U.S. Application Data
(60) Provisional application No. 63/644,816, filed on May 9, 2024.

(51) Int. Cl. G06F 9/451; G06F 21/32

(52) U.S. Cl. CPC G06F 9/452; G06F 21/32

(57) ABSTRACT

A method and a system for expediting a virtual desktop session logon by triggering an anticipated onset of a session and populating the session with applications and data before a user is present are provided. The method includes: receiving first information that relates to items, such as applications and data, to be rendered accessible during a virtual desktop session to be conducted by a person; receiving second information that relates to a planned time at which the person expects to initiate the virtual desktop session; populating, prior to the planned time by several minutes, the virtual desktop session based on the first information; receiving, from the person, a readiness indication for starting the virtual desktop session; and initiating the populated virtual desktop session such that the person is fully able to conduct the populated virtual desktop session within 60 seconds of the receiving of the readiness indication.

### CROSS-REFERENCE TO RELATED APPLICATION

This application claims the benefit of U.S. Provisional Ser. No. 63/644,816, filed May 9, 2024, which is hereby incorporated by reference in its entirety.

### BACKGROUND

### 1. Field of the Disclosure

This technology relates to methods and systems for expediting a virtual desktop session logon by triggering an anticipated onset of a session and populating the session with applications and data before a user is present.

### 2. Background Information

In an era marked by rapid technological innovation, it is crucial to a workplace to harness technological advancements and deliver an enriched employee experience that is modern, inclusive, flexible, sustainable, and reliable.

In the advanced digital workspace, workdays are characterized by efficiency, convenience, and personalized productivity. The journey of a typical employee starts with accessing the building through a digital badge, then proceeding to the office floor and arriving at an easily identifiable, pre-configured desk. The endpoint is readily available and easy to unlock through a passwordless login option, which is swift and straightforward. The workday is rapidly initiated, facilitating a connection to essential collaborative tools. A high level of optionality is provided. Work can be initiated from a variety of devices, such as a personal laptop, a corporate personal computer, a virtual desktop infrastructure (VDI) and a mobile device, and the employee may have the same familiar and pleasant experience accessing all of a variety of productivity tools, such as Zoom and Teams, Office, corporate applications and more.

The employee has access to do everything that he/she needs to do. Co-creating content is remarkably streamlined, allowing the employee to concentrate on individual tasks within an optimized environment. The workspace intelligently adapts to the employee's needs, offering a fluid transition from desktop to mobile as the employee navigates the office for performance of day-to-day responsibilities. Locating available collaborative spaces equipped with advanced digital whiteboard capabilities for ongoing ideation has become effortless. The employee is able to choose meeting rooms based on technology, privacy and capacity needs. Intelligent lighting and automated room booking systems enhance the workspace experience, while the modern applications being used ensure all appropriate meeting content can be shared with meeting attendees during and post meeting.

A guiding principle driving these new work experiences is the reduction and, where possible, the elimination of undesirable idle time. This is the period of unproductive time that the employee typically spends at the start of their work week, transitioning work locations, changing modes of work, or moving between tasks. The common thread woven into all future designs is to understand and anticipate the need and intent of an employee's work style. This data may be used to stage and/or pre-build technology that is in a ready-to-work state in anticipation of employee demand. A practical example of this capability would be demonstrated in the target state workstation login experience. The experience of an employee logging into a desktop, and waiting for that desktop to self-configure, would be replaced with an experience where the employee's movement towards or arrival at an office would trigger automation to prefabricate their desired workstation experience. An employee may be able to self-select the granularity of this experience to be as basic as a ready-to-use workstation or as complex as the ability to specify applications to pre-launch as well as screen arrangement of applications and their sizing.

Accordingly, there is a need for a method for expediting a virtual desktop session logon by triggering an anticipated onset of a session and populating, or “hydrating,” the session with applications and data before a user is present.

### SUMMARY

The present disclosure, through one or more of its various aspects, embodiments, and/or specific features or sub-components, provides, inter alia, various systems, servers, devices, methods, media, programs, and platforms for expediting a virtual desktop session logon by triggering an anticipated onset of a session and populating the session with applications and data before a user is present.

According to an aspect of the present disclosure, a method for expediting an initiation of a virtual desktop session is provided. The method is implemented by at least one processor. The method includes: receiving, by the at least one processor, first information that relates to items to be rendered accessible during a first virtual desktop session to be conducted by a first individual person; receiving, by the at least one processor, second information that relates to a future first time at which the first individual person expects to initiate the first virtual desktop session; populating, by the at least one processor at a second time that is prior to the future first time by a predetermined amount of time, the first virtual desktop session based on the first information; receiving, by the at least one processor from the first individual person, a readiness indication that the first individual person is ready to begin the first virtual desktop session; and initiating, by the at least one processor in response to the received readiness indication, the populated first virtual desktop session such that the first individual person is fully able to conduct the populated first virtual desktop session within sixty (60) seconds of the receiving of the readiness indication.

The first information may include at least one from among a list of applications to be used by the first individual person during the first virtual desktop session and a first set of data to be accessed by the first individual person during the first virtual desktop session.

The predetermined amount of time may be greater than five minutes and less than ten minutes.

The readiness indication may include at least one from among a password and a biometric signature associated with the first individual person.

The biometric signature may include at least one from among a fingerprint, a facial image that is usable for performing a facial recognition operation, and an iris image that is usable for performing an iris recognition operation.

The method may further include: receiving an indication that the first individual person is ready to conclude the populated first virtual desktop session, together with a projection of a third time at which the first individual person plans to begin a next virtual desktop session; depopulating the first virtual desktop session by removing access to the items indicated by the first information; terminating the first virtual desktop session; and populating, by the at least one processor at a fourth time that is prior to the third time by the predetermined amount of time, the second virtual desktop session based on the first information.

The method may further include: for at least one application that is accessible via the first virtual desktop session and that relates to collaborating with other individual persons, facilitating an ability of the first individual person to access the at least one application by performing one from among a single mouse click and a single touch.

The method may further include: when the first virtual desktop session is suspended as a result of inactivity by the first individual person, facilitating an ability of the first individual person to resume the first virtual desktop session by providing a biometric signature associated with the first individual person.

The first information may be received from an employee workplace application that stores and applies preferences associated with the first individual person.

According to another embodiment, a computing apparatus for expediting an initiation of a virtual desktop session is provided. The computing apparatus includes a processor; a memory; and a communication interface coupled to each of the processor and the memory. The processor may be configured to: receive, via the communication interface, first information that relates to items to be rendered accessible during a first virtual desktop session to be conducted by a first individual person; receive, via the communication interface, second information that relates to a future first time at which the first individual person expects to initiate the first virtual desktop session; populate, at a second time that is prior to the future first time by a predetermined amount of time, the first virtual desktop session based on the first information; receive, from the first individual person via the communication interface, a readiness indication that the first individual person is ready to begin the first virtual desktop session; and initiate, in response to the received readiness indication, the populated first virtual desktop session such that the first individual person is fully able to conduct the populated first virtual desktop session within sixty (60) seconds of the receiving of the readiness indication.

The first information may include at least one from among a list of applications to be used by the first individual person during the first virtual desktop session and a first set of data to be accessed by the first individual person during the first virtual desktop session.

The predetermined amount of time may be greater than five minutes and less than ten minutes.

The readiness indication may include at least one from among a password and a biometric signature associated with the first individual person.

The biometric signature may include at least one from among a fingerprint, a facial image that is usable for performing a facial recognition operation, and an iris image that is usable for performing an iris recognition operation.

The processor may be further configured to: receive, via the communication interface, an indication that the first individual person is ready to conclude the populated first virtual desktop session, together with a projection of a third time at which the first individual person plans to begin a next virtual desktop session; depopulate the first virtual desktop session by removing access to the items indicated by the first information; terminate the first virtual desktop session; and populate, at a fourth time that is prior to the third time by the predetermined amount of time, the next virtual desktop session based on the first information.

The processor may be further configured to: for at least one application that is accessible via the first virtual desktop session and that relates to collaborating with other individual persons, facilitate an ability of the first individual person to access the at least one application by performing one from among a single mouse click and a single touch.

The processor may be further configured to: when the first virtual desktop session is suspended as a result of inactivity by the first individual person, facilitate an ability of the first individual person to resume the first virtual desktop session by providing a biometric signature associated with the first individual person.

The first information may be received from an employee workplace application that stores and applies preferences associated with the first individual person.

According to yet another embodiment, a non-transitory computer readable storage medium storing instructions for expediting an initiation of a virtual desktop session is provided. The storage medium includes a set of executable code which, when executed by a processor, causes the processor to: receive first information that relates to items to be rendered accessible during a first virtual desktop session to be conducted by a first individual person; receive second information that relates to a future first time at which the first individual person expects to initiate the first virtual desktop session; populate, at a second time that is prior to the future first time by a predetermined amount of time, the first virtual desktop session based on the first information; receive, from the first individual person, a readiness indication that the first individual person is ready to begin the first virtual desktop session; and initiate, in response to the received readiness indication, the populated first virtual desktop session such that the first individual person is fully able to conduct the populated first virtual desktop session within sixty (60) seconds of the receiving of the readiness indication.

The first information may include at least one from among a list of applications to be used by the first individual person during the first virtual desktop session and a first set of data to be accessed by the first individual person during the first virtual desktop session.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for expediting a virtual desktop session logon by triggering an anticipated onset of a session and populating the session with applications and data before a user is present.

FIG. 4 is a flowchart of an exemplary process for implementing a method for expediting a virtual desktop session logon by triggering an anticipated onset of a session and populating the session with applications and data before a user is present.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

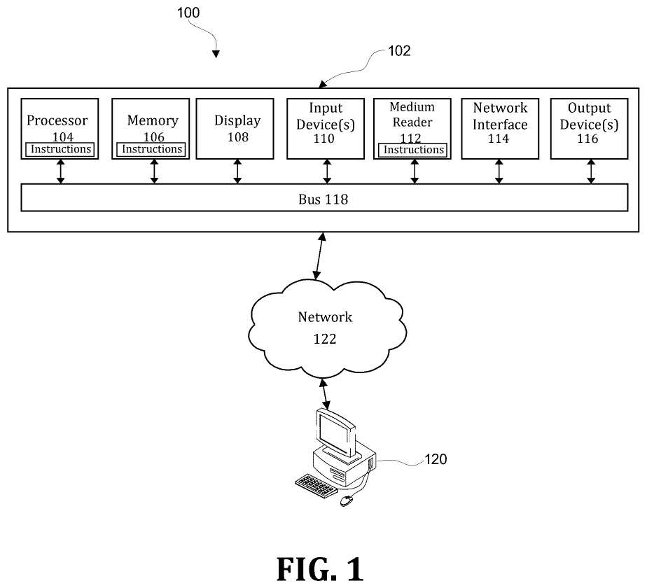

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for expediting a virtual desktop session logon by triggering an anticipated onset of a session and populating the session with applications and data before a user is present.

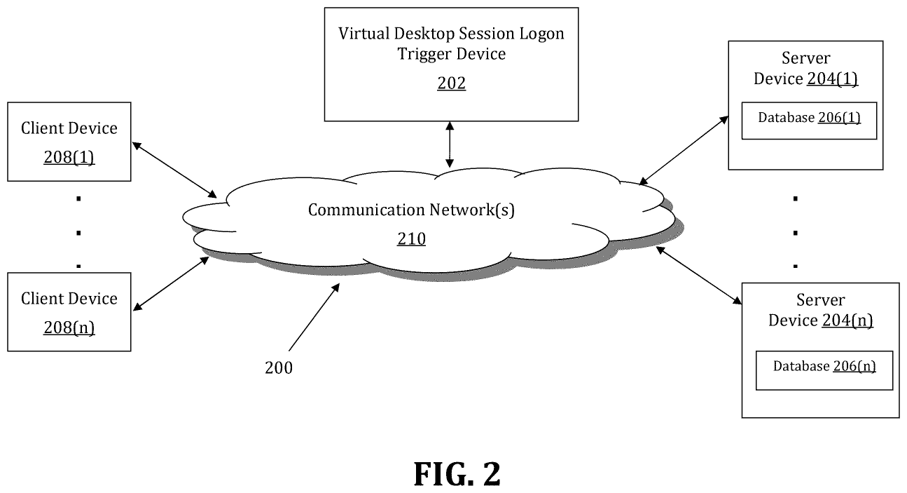

Referring to FIG. 2, a schematic of an exemplary network environment 200 for implementing a method for expediting a virtual desktop session logon by triggering an anticipated onset of a session and populating the session with applications and data before a user is present is illustrated. In an exemplary embodiment, the method is executable on any networked computer platform, such as, for example, a personal computer (PC).

The method for expediting a virtual desktop session logon by triggering an anticipated onset of a session and populating the session with applications and data before a user is present may be implemented by a Virtual Desktop Session Logon Trigger (VDSLT) device 202. The VDSLT device 202 may be the same or similar to the computer system 102 as described with respect to FIG. 1. The VDSLT device 202 may store one or more applications that can include executable instructions that, when executed by the VDSLT device 202, cause the VDSLT device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the VDSLT device 202 itself, may be located in virtual server(s) running in a cloud-based computing environment rather than being tied to one or more specific physical network computing devices. Also, the application(s) may be running in one or more virtual machines (VMs) executing on the VDSLT device 202. Additionally, in one or more embodiments of this technology, virtual machine(s) running on the VDSLT device 202 may be managed or supervised by a hypervisor.

In the network environment 200 of FIG. 2, the VDSLT device 202 is coupled to a plurality of server devices 204(1)-204(n) that hosts a plurality of databases 206(1)-206(n), and also to a plurality of client devices 208(1)-208(n) via communication network(s) 210. A communication interface of the VDSLT device 202, such as the network interface 114 of the computer system 102 of FIG. 1, operatively couples and communicates between the VDSLT device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the VDSLT device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and VDSLT devices that efficiently implement a method for expediting a virtual desktop session logon by triggering an anticipated onset of a session and populating, or hydrating, the session with applications and data before a user is present.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The VDSLT device 202 may be a standalone device or integrated with one or more other devices or apparatuses, such as one or more of the server devices 204(1)-204(n), for example. In one particular example, the VDSLT device 202 may include or be hosted by one of the server devices 204(1)-204(n), and other arrangements are also possible. Moreover, one or more of the devices of the VDSLT device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the VDSLT device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information that relates to user-specific desktop configurations and applications and information that relates to user-specific schedules.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the VDSLT device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the VDSLT device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the VDSLT device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the VDSLT device 202, the server devices 204(1)-204(n), or the client devices 208(1)-208(n), for example, may be configured to operate as virtual instances on the same physical machine. In other words, one or more of the VDSLT device 202, the server devices 204(1)-204(n), or the client devices 208(1)-208(n) may operate on the same physical device rather than as separate devices communicating through communication network(s) 210. Additionally, there may be more or fewer VDSLT devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

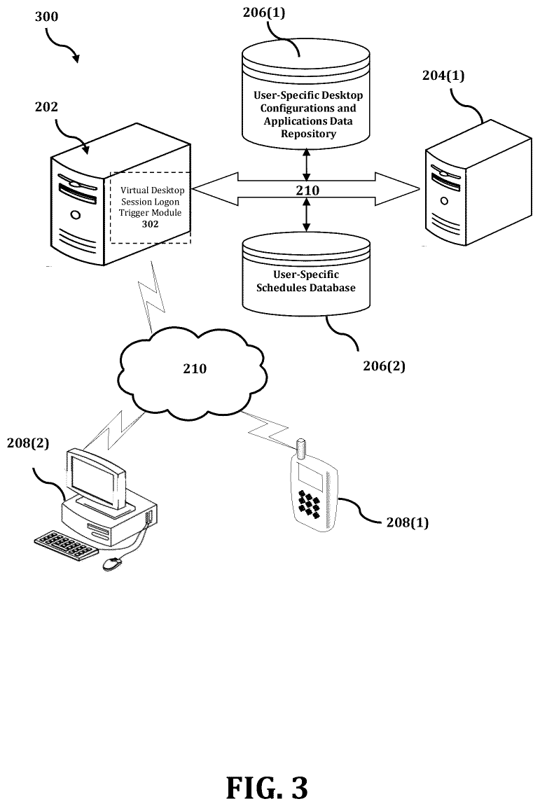

The VDSLT device 202 is described and illustrated in FIG. 3 as including a virtual desktop session logon trigger module 302, although it may include other rules, policies, modules, databases, or applications, for example. As will be described below, the virtual desktop session logon trigger module 302 is configured to implement a method for expediting a virtual desktop session logon by triggering an anticipated onset of a session and populating the session with applications and data before a user is present.

An exemplary process 300 for implementing a mechanism for expediting a virtual desktop session logon by triggering an anticipated onset of a session and populating the session with applications and data before a user is present by utilizing the network environment of FIG. 2 is illustrated as being executed in FIG. 3. Specifically, a first client device 208(1) and a second client device 208(2) are illustrated as being in communication with VDSLT device 202. In this regard, the first client device 208(1) and the second client device 208(2) may be “clients” of the VDSLT device 202 and are described herein as such. Nevertheless, it is to be known and understood that the first client device 208(1) and/or the second client device 208(2) need not necessarily be “clients” of the VDSLT device 202, or any entity described in association therewith herein. Any additional or alternative relationship may exist between either or both of the first client device 208(1) and the second client device 208(2) and the VDSLT device 202, or no relationship may exist.

Further, VDSLT device 202 is illustrated as being able to access a user-specific desktop configurations and applications data repository 206(1) and a user-specific schedules database 206(2). The virtual desktop session logon trigger module 302 may be configured to access these databases for implementing a method for expediting a virtual desktop session logon by triggering an anticipated onset of a session and populating the session with applications and data before a user is present.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the VDSLT device 202 via broadband or cellular communication. Of course, these embodiments are merely exemplary and are not limiting or exhaustive.

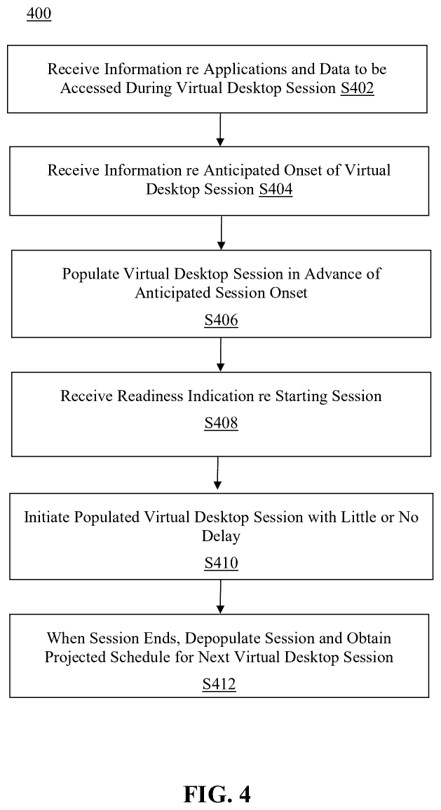

Upon being started, the virtual desktop session logon trigger module 302 executes a process for expediting a virtual desktop session logon by triggering an anticipated onset of a session and populating the session with applications and data before a user is present. An exemplary process for expediting a virtual desktop session logon by triggering an anticipated onset of a session and populating the session with applications and data before a user is present is generally indicated at flowchart 400 in FIG. 4.

In process 400 of FIG. 4, at step S402, the virtual desktop session logon trigger module 302 receives a first set of information that relates to items to be rendered accessible during a virtual desktop session that is to be conducted by an individual person. In an exemplary embodiment, the items to be rendered accessible may include any one or more of a list of applications to be used by the individual person during the virtual desktop session and/or data set(s) to be accessed during the virtual desktop session.

At step S404, the virtual desktop session logon trigger module 302 receives a second set of information that relates to a future time at which the individual person anticipates an onset of the virtual desktop session. In an exemplary embodiment, the person may typically initiate a session every Monday morning at 9:00 am, and the session may terminate each weekday at 5:00 pm, in which case a new session may begin each weekday morning; or a single session may persist through the work week until the close of business on Friday, in which case a new session may begin the following Monday morning.

At step S406, the virtual desktop session logon trigger module 302 populates the virtual desktop session in advance of the anticipated onset thereof by pre-loading, or “hydrating” or “pre-hydrating”, the session with the applications and data that are indicated by the first information received in step S402. In an exemplary embodiment, the populating of the virtual desktop session is timed to begin shortly before the anticipated session onset, so that it will be ready when the session is actually initiated. For example, the populating may begin at a time that is at least five minutes before the anticipated session onset, but no more than ten minutes before the anticipated session onset, in a circumstance for which the population operation would require a few minutes.

At step S408, the virtual desktop session logon trigger module 302 receives a readiness indication from the person as an indication that the person is then ready to start the planned virtual desktop session. In an exemplary embodiment, the readiness indication may include any one or more of a password and a biometric signature associated with the person, such as, for example, a fingerprint, a facial image that is usable for performing a facial recognition operation, and/or an iris image that is usable for performing an iris recognition operation. Then, at step S410, in response to the receiving of the readiness indication, the virtual desktop session logon trigger module 302 initiates the virtual desktop session. In an embodiment, the initiation of the virtual desktop session occurs relatively quickly, such as, for example, within sixty (60) seconds of the receiving of the readiness indication, so that the person is fully able to conduct the populated virtual desktop session within the 60-second time frame.

At step S412, when the time comes to terminate the virtual desktop session, the virtual desktop session logon trigger module 302 may receive an indication that the person is ready to conclude the session, together with a projection of a time at which the person plans to begin the next virtual desktop session. In response, the virtual desktop session logon trigger module 303 depopulates the current virtual desktop session by removing the access to the applications and data indicated in the first set of information, and then terminating the session. The virtual desktop session logon trigger module 302 may then use the received projection to schedule a time for repeating the process 400 so that the next virtual desktop session will be populated in advance of the actual initiation thereof by the individual person.

In an exemplary embodiment, a guiding principle is the reduction and, where possible, the elimination of “undesirable idle time” by employees. This is the period of unproductive time employees spend at the start of their work week, transitioning work locations, changing modes of work, or moving between tasks. Accordingly, one objective is to understand and anticipate the need and intent of an employee's work style. This data is used to stage and or pre-build technology that is in a “ready to work” state in anticipation of employee demand.

A practical example of this capability is demonstrable in the target state workstation login experience. In an exemplary embodiment, the experience of an employee logging into a desktop, and waiting for that desktop to self-configure is replaced with an experience where the employee's movement towards or arrival at an office triggers automation to prefabricate their desired workstation experience. Employees are able to self-select the granularity of this experience to be as basic as a ready to use workstation or as complex as the ability to specify applications to pre-launch as well as screen arrangement of applications and their sizing.

Assumptions: 1) There is sufficient telemetry for driving the above-described automation. In an exemplary embodiment, this telemetry is supplied by an employee workplace application. 2) There is a system that stores and applies employee preferences across all employee facing technology. 3) The methodology of the present inventive concept applies to virtual desktop infrastructure (VDI), physical desktops, and physical laptops and mobile devices.

Risks: 1) Automated logins of this nature represent a significant departure from conventional employee authentication mechanisms, and, as such, may require additional approaches and technologies with respect to employee authentication. Security concerns regarding automated employee logins of this nature can be addressed and satisfied. 2) The experience described in the present disclosure places complex automation directly in the path of a successful employee login experience. To ensure reliability and consistency in employee experience, this complexity is accompanied by a commensurate level of observability. 3) To be useful and cost effective, the present inventive concept requires a critical mass of employee telemetry. In this aspect, the perception of intrusiveness could hamper employees that opt to use this feature.

Ability to Seamlessly Join Meeting on Teams/Zoom: Prior to the implementation of the present inventive concept, transitioning between individual and collaborative work styles has relied heavily on the employee properly navigating multiple technologies. The present inventive concept overcomes this burden by developing interoperability between applications to launch and join collaboration sessions with a single touch or click. To drive further simplicity, this “one-click” capability is not be limited to collaboration-specific applications, but instead also is usable in applications where collaboration is common. In an exemplary embodiment, this feature is available as a plugin that is embeddable in virtually any application, webpage, workflow, or document. The ubiquity of this approach makes it portable across virtual desktops, physical desktops, mobile devices, and collaboration hardware platforms.

Instant Login When Returning to Desk: Conventionally, users have typically logged in to their VDI using their username and password. Most users frequently leave and then return to their desk regularly throughout the day, thus requiring them to lock and unlock their workstation. The action of unlocking may require them to input a long password, often multiple times a day.

In an exemplary embodiment, the passwordless authentication feature effectively replaces the requirement for a long password, thereby allowing a user to quickly unlock their workstation when returning to their desk. In place of the long password, this feature uses a mobile app that leverages the user's biometric signature (i.e., fingerprint or facial recognition). As a result, the friction of having to remember and type a long password to unlock their workstation each time is significantly reduced.

For some types of workstations, users can simply use a touch ID fingerprint sensor on their laptop or keyboard to unlock their device almost instantaneously. If a user has been away for a longer period of time, they may also be prompted to re-authenticate by using the passwordless authentication feature described above.

Accordingly, with this technology, an optimized process for expediting a virtual desktop session logon by triggering an anticipated onset of a session and populating the session with applications and data before a user is present is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for expediting an initiation of a virtual desktop session, the method being implemented by at least one processor, the method comprising:
receiving, by the at least one processor, first information that relates to items to be rendered accessible during a first virtual desktop session to be conducted by a first individual person;
receiving, by the at least one processor, second information that relates to a future first time at which the first individual person expects to initiate the first virtual desktop session;
populating, by the at least one processor at a second time that is prior to the future first time by a predetermined amount of time, the first virtual desktop session based on the first information;
receiving, by the at least one processor from the first individual person, a readiness indication that the first individual person is ready to begin the first virtual desktop session; and
initiating, by the at least one processor in response to the received readiness indication, the populated first virtual desktop session such that the first individual person is fully able to conduct the populated first virtual desktop session within sixty (60) seconds of the receiving of the readiness indication.

2. The method of claim 1, wherein the first information comprises at least one from among a list of applications to be used by the first individual person during the first virtual desktop session and a first set of data to be accessed by the first individual person during the first virtual desktop session.

3. The method of claim 1, wherein the predetermined amount of time is greater than five minutes and less than ten minutes.

4. The method of claim 1, wherein the readiness indication includes at least one from among a password and a biometric signature associated with the first individual person.

5. The method of claim 4, wherein the biometric signature includes at least one from among a fingerprint, a facial image that is usable for performing a facial recognition operation, and an iris image that is usable for performing an iris recognition operation.

6. The method of claim 1, further comprising:
receiving an indication that the first individual person is ready to conclude the populated first virtual desktop session, together with a projection of a third time at which the first individual person plans to begin a next virtual desktop session;
depopulating the first virtual desktop session by removing access to the items indicated by the first information;
terminating the first virtual desktop session; and
populating, by the at least one processor at a fourth time that is prior to the third time by the predetermined amount of time, the next virtual desktop session based on the first information.

7. The method of claim 1, further comprising: for at least one application that is accessible via the first virtual desktop session and that relates to collaborating with other individual persons, facilitating an ability of the first individual person to access the at least one application by performing one from among a single mouse click and a single touch.

8. The method of claim 1, further comprising: when the first virtual desktop session is suspended as a result of inactivity by the first individual person, facilitating an ability of the first individual person to resume the first virtual desktop session by providing a biometric signature associated with the first individual person.

9. The method of claim 1, wherein the first information is received from an employee workplace application that stores and applies preferences associated with the first individual person.

10. A computing apparatus for expediting an initiation of a virtual desktop session, the computing apparatus comprising:
a processor;
a memory; and
a communication interface coupled to each of the processor and the memory,
wherein the processor is configured to:
receive, via the communication interface, first information that relates to items to be rendered accessible during a first virtual desktop session to be conducted by a first individual person;
receive, via the communication interface, second information that relates to a future first time at which the first individual person expects to initiate the first virtual desktop session;
populate, at a second time that is prior to the future first time by a predetermined amount of time, the first virtual desktop session based on the first information;
receive, from the first individual person via the communication interface, a readiness indication that the first individual person is ready to begin the first virtual desktop session; and
initiate, in response to the received readiness indication, the populated first virtual desktop session such that the first individual person is fully able to conduct the populated first virtual desktop session within sixty (60) seconds of the receiving of the readiness indication.

11. The computing apparatus of claim 10, wherein the first information comprises at least one from among a list of applications to be used by the first individual person during the first virtual desktop session and a first set of data to be accessed by the first individual person during the first virtual desktop session.

12. The computing apparatus of claim 10, wherein the predetermined amount of time is greater than five minutes and less than ten minutes.

13. The computing apparatus of claim 10, wherein the readiness indication includes at least one from among a password and a biometric signature associated with the first individual person.

14. The computing apparatus of claim 13, wherein the biometric signature includes at least one from among a fingerprint, a facial image that is usable for performing a facial recognition operation, and an iris image that is usable for performing an iris recognition operation.

15. The computing apparatus of claim 10, wherein the processor is further configured to:
receive, via the communication interface, an indication that the first individual person is ready to conclude the populated first virtual desktop session, together with a projection of a third time at which the first individual person plans to begin a next virtual desktop session;
depopulate the first virtual desktop session by removing access to the items indicated by the first information;
terminate the first virtual desktop session; and
populate, at a fourth time that is prior to the third time by the predetermined amount of time, the next virtual desktop session based on the first information.

16. The computing apparatus of claim 10, wherein the processor is further configured to: for at least one application that is accessible via the first virtual desktop session and that relates to collaborating with other individual persons, facilitate an ability of the first individual person to access the at least one application by performing one from among a single mouse click and a single touch.

17. The computing apparatus of claim 10, wherein the processor is further configured to: when the first virtual desktop session is suspended as a result of inactivity by the first individual person, facilitate an ability of the first individual person to resume the first virtual desktop session by providing a biometric signature associated with the first individual person.

18. The computing apparatus of claim 10, wherein the first information is received from an employee workplace application that stores and applies preferences associated with the first individual person.

19. A non-transitory computer readable storage medium storing instructions for expediting an initiation of a virtual desktop session, the storage medium comprising executable code which, when executed by a processor, causes the processor to:
receive first information that relates to items to be rendered accessible during a first virtual desktop session to be conducted by a first individual person;
receive second information that relates to a future first time at which the first individual person expects to initiate the first virtual desktop session;
populate, at a second time that is prior to the future first time by a predetermined amount of time, the first virtual desktop session based on the first information;
receive, from the first individual person, a readiness indication that the first individual person is ready to begin the first virtual desktop session; and
initiate, in response to the received readiness indication, the populated first virtual desktop session such that the first individual person is fully able to conduct the populated first virtual desktop session within sixty (60) seconds of the receiving of the readiness indication.

20. The storage medium of claim 19, wherein the first information comprises at least one from among a list of applications to be used by the first individual person during the first virtual desktop session and a first set of data to be accessed by the first individual person during the first virtual desktop session.
